(19) United States
(12) Patent Application Publication
(10) Pub. No.: US 2020/0307134 A1
(43) Pub. Date: Oct. 1, 2020

(54) METHOD FOR PRODUCING SOLE STRUCTURE MEMBER

(71) Applicant: Mizuno Corporation, Osaka (JP)

(72) Inventors: Yohei Yoshida, Osaka (JP); Shingo Sudo, Osaka (JP); Yuichi Shimizu, Osaka (JP); Shin Hirai, Osaka (JP)

(21) Appl. No.: 16/812,665

(22) Filed: Mar. 9, 2020

(30) Foreign Application Priority Data
Mar. 27, 2019 (JP) 2019-060357

(51) Int. Cl. B29D 35/12; A43B 13/04; B29D 35/00

(52) U.S. Cl. CPC B29D 35/122; A43B 13/04; B29L 2031/504; B29D 35/128; B29D 35/0018

(57) ABSTRACT

A method for producing a sole structure member includes: selecting at least one first sub-member from an optional group consisting of a plurality of types of first sub-members premolded such that their respective recesses have different configurations; inserting, and housing, the at least one first sub-member selected from the optional group in a housing; and molding the first and second sub-members so as to be integrated together through injection of the second resin material heated to melt, from a gate into a molding space and a channel.

### CROSS-REFERENCE TO RELATED APPLICATION

This application claims priority to Japanese Patent Application No. 2019-060357 filed on Mar. 27, 2019, the entire disclosure of which is incorporated by reference herein.

### BACKGROUND

The present disclosure relates to a method for producing a sole structure member for use in a shoe.

A method for producing a sole structure for use in a shoe, disclosed in Japanese Translation of PCT International Application No. 2015-518772, for example, has been known.

Japanese Translation of PCT International Application No. 2015-518772 discloses a method for producing a sole structure. In this method, a shoe sole structure including a plate member made of a first material and a cleat tip portion made of a second material having a rigidity different from that of the first material is produced using a mold apparatus (a molding assembly).

### SUMMARY

In general, the bending and torsional rigidities of shoes (in particular, sports shoes) are important factors to enhance sports performance, the ability of motion in daily activities, or any other abilities. The bending and torsional rigidities required by individual wearers vary among areas of shoes, the wearers' abilities of motion, characteristics of foot motion in various competitions, the shapes of the wearers' feet, and the degrees of stiffness of the wearers' ankle joints (morphologic characteristics of the feet). Therefore, there has been a need to provide a shoe (sole structure) having a rigidity suitable for each of the wearers.

In the production method of Japanese Translation of PCT International Application No. 2015-518772, only one sole structure including members (a plate member and a cleat tip portion) having a uniquely determined shape and uniquely positioned relative to each other is produced using one mold apparatus (a molding assembly). In other words, the method merely produces a sole structure having uniquely determined bending and torsional rigidities, using one mold apparatus. In order to produce a plurality of types of sole structures having different rigidities, materials for the members may be varied as appropriate, or a plurality of mold apparatuses may be prepared in advance. However, these processes are both complicated. As can be seen, the production method of Japanese Translation of PCT International Application No. 2015-518772 does not make it easy to provide a plurality of types of sole structures having rigidities suitable for the individual wearers' characteristics or preferences as described above.

In view of the foregoing background, it is an object of the present disclosure to easily provide a plurality of types of sole structure members having rigidities suitable for individual wearers' characteristics or preferences.

To achieve the object, a first aspect of the present disclosure is directed to a method for producing a sole structure member for use in a shoe, using a mold apparatus. The sole structure member includes at least one first sub-member made of a first resin material, and a second sub-member made of a second resin material having a rigidity different from a rigidity of the first resin material. The at least one first sub-member has a first body portion, and at least one recess or hole formed in the at least one first body portion. The second sub-member has at least one branch portion positioned to correspond to the at least one recess or hole of the first sub-member. The mold apparatus includes: a molding space configured to mold the sole structure member; a housing provided inside the molding space and for housing the at least one first sub-member; a channel configured as a space surrounded by the at least one recess or hole and the molding space; and a gate communicating with at least either the molding space or the channel and for injecting the second resin material into the molding space and the channel. The method includes: selecting the at least one first sub-member from an optional group consisting of a plurality of types of the first sub-members premolded such that their respective recesses or holes have different configurations; inserting, and housing, in the housing the at least one first sub-member selected from the optional group; and molding the first and second sub-members so as to be integrated together through injection of the second resin material heated to melt, from the gate into the molding space and the channel.

The method according to the first aspect of the present disclosure includes selecting the at least one first sub-member from an optional group consisting of a plurality of types of the first sub-members premolded such that their respective recesses or holes have different configurations. For example, if, in this process, the first sub-members of two patterns are selected from the optional group, the difference in the configuration of the recess between these patterns causes the branch portions of the second sub-member, which are molded through injection of the second resin material from the gate into the channel in the molding, to have different configurations that differ between the patterns. Specifically, a sole structure member including the first sub-member of one of the patterns has a rigidity different from that of a sole structure member including the first sub-member of the other pattern, due to the configurations of the branch portions that differ between the patterns. As a result, a plurality of types of sole structure members having basically the same outer shapes and different only in rigidity can be produced using the single mold apparatus. Thus, in the first aspect, a plurality of types of sole structure members having rigidities suitable for wearers' characteristics or preferences can be easily provided.

A second aspect of the present disclosure is an embodiment of the first aspect. In the second aspect, the second resin material may be more rigid than the first resin material.

According to the second aspect, the rigidity of the branch portions of the second sub-member can be appropriately changed depending on the size, relative position, and number of the at least one recess or hole of the first sub-member selected from the optional group. Thus, in producing the sole structure member, its rigidity can be easily adjusted to be suitable for wearers' characteristics or preferences.

A third aspect of the present disclosure is an embodiment of the first aspect. In the third aspect, the first resin material may be a transparent resin material.

According to the third aspect, since the first resin material is a transparent resin material, the first sub-member looks transparent. Thus, when the sole structure member is viewed, features (the shape, relative positions, number, and other features) of the branch portions corresponding in position to the at least one recess or hole is more easily recognized. This enables easy production of a sole structure member having a degree of rigidity that is visible based on the visual features of the branch portions.

A fourth aspect of the present disclosure is an embodiment of the first aspect. In the fourth aspect, in a state in which the sole structure member is used for the shoe, the at least one recess or hole of the at least one first sub-member may extend in a length direction of a foot of a wearer wearing the shoe.

The fourth aspect enables easy production of a sole structure member configured to increase the bending rigidity of the shoe in the foot length direction.

A fifth aspect of the present disclosure is an embodiment of the first aspect. In the fifth aspect, in a state in which the sole structure member is used for the shoe, the at least one recess or hole of the at least one first sub-member may be positioned to correspond to MTP joints of a foot of a wearer wearing the shoe.

The fifth aspect enables easy production of a sole structure member configured to increase the rigidity of a portion of the shoe corresponding to the MTP joints of the wearer's foot.

A sixth aspect of the present disclosure is an embodiment of the first aspect. In the sixth aspect, in a state in which the sole structure member is used for the shoe, the at least one recess or hole of the at least one first sub-member may be positioned to correspond to a midfoot portion of a foot of a wearer wearing the shoe.

The sixth aspect enables easy production of a sole structure member configured to increase the rigidity of a portion of the shoe corresponding to the midfoot portion (e.g., the plantar arch portion) of the wearer's foot.

As described above, according to the present disclosure, a plurality of types of sole structure members having rigidities suitable for wearers' characteristics or preferences can be easily provided.

### BRIEF DESCRIPTION OF THE DRAWINGS

FIG. 1 is an overall perspective view illustrating a sole structure member including first sub-members of a pattern A selected from an optional group in a first embodiment of the present disclosure.

FIG. 2 is a bottom view illustrating a configuration of a portion of the sole structure member illustrated in FIG. 1, as viewed from the bottom.

FIG. 3 is a perspective view illustrating a state where the first sub-members of the pattern A are about to be housed in a molding space (a housing of a lower mold) of a mold apparatus in inserting.

FIG. 4 is a perspective view illustrating a state where the first sub-members of the pattern A are housed in the molding space (the housing of the lower mold) of the mold apparatus in the inserting.

FIG. 5 is a perspective view illustrating a state where an upper mold is placed on top of the lower mold housing the first sub-members of the pattern A.

FIG. 6 is a vertical sectional view schematically showing cross-sectional configurations of the first sub-members of the pattern A and the mold apparatus, taken along a lateral direction of the mold apparatus, in a state where the first sub-members are housed in the housing of the mold apparatus.

FIG. 7 is a perspective view illustrating a state where the first sub-members of the pattern A and a second sub-member have been integrated together in molding.

FIG. 8 is an overall perspective view illustrating a sole structure member including first sub-members of a pattern B selected from the optional group in the first embodiment of the present disclosure.

FIG. 9 is a bottom view illustrating a configuration of a portion of the sole structure member illustrated in FIG. 8, as viewed from the bottom.

FIG. 10 is a perspective view illustrating a state where the first sub-members of the pattern B are housed in the molding space (the housing of the lower mold) of the mold apparatus in the inserting.

FIG. 11 is a perspective view illustrating a state where the first sub-members of the pattern B and a second sub-member have been integrated together in molding.

FIG. 12 is a side view illustrating a shoe including a sole structure member according to a second embodiment of the present disclosure.

FIG. 13 is a bottom view illustrating a shoe including a sole structure member including a first sub-member of a pattern C selected from the optional group in the second embodiment of the present disclosure.

FIG. 14 is a perspective view illustrating a state where the first sub-member of the pattern C is housed in a molding space (a housing of a lower mold) of a mold apparatus in inserting.

FIG. 15 is an enlarged cross-sectional view taken along line XV-XV shown in FIG. 14.

FIG. 16 corresponds to FIG. 15 and illustrates a state where the upper mold is placed on top of the lower mold in the state shown in FIG. 14.

FIG. 17 is a perspective view illustrating a state where the first sub-member of the pattern C and a second sub-member have been integrated together in molding.

FIG. 18 is a bottom view illustrating a shoe including a sole structure member including a first sub-member of a pattern D selected from the optional group in the second embodiment of the present disclosure.

FIG. 19 is a perspective view illustrating a state where the first sub-member of the pattern D is housed in the molding space (the housing of the lower mold) of the mold apparatus in the inserting.

FIG. 20 is a perspective view illustrating a state where the first sub-member of the pattern D and a second sub-member have been integrated together in molding.

FIG. 21 corresponds to FIG. 15 and illustrates, as a variation of the second embodiment of the present disclosure, a state where a variation of the first sub-member of the pattern C is housed in the molding space (the housing of the lower mold) of the mold apparatus in inserting.

FIG. 22 corresponds to FIG. 6 and illustrates a configuration in which a recess of each of the first sub-members is replaced with a hole according to another embodiment.

FIG. 23 corresponds to FIG. 16 and illustrates a configuration in which recesses of the first sub-member are replaced with holes according to still another embodiment.

### DETAILED DESCRIPTION

Embodiments of the present disclosure will now be described in detail with reference to the drawings. Note that the following description of the embodiments is a mere example in nature, and is not intended to limit the scope, application, or uses of the present disclosure.

### First Embodiment

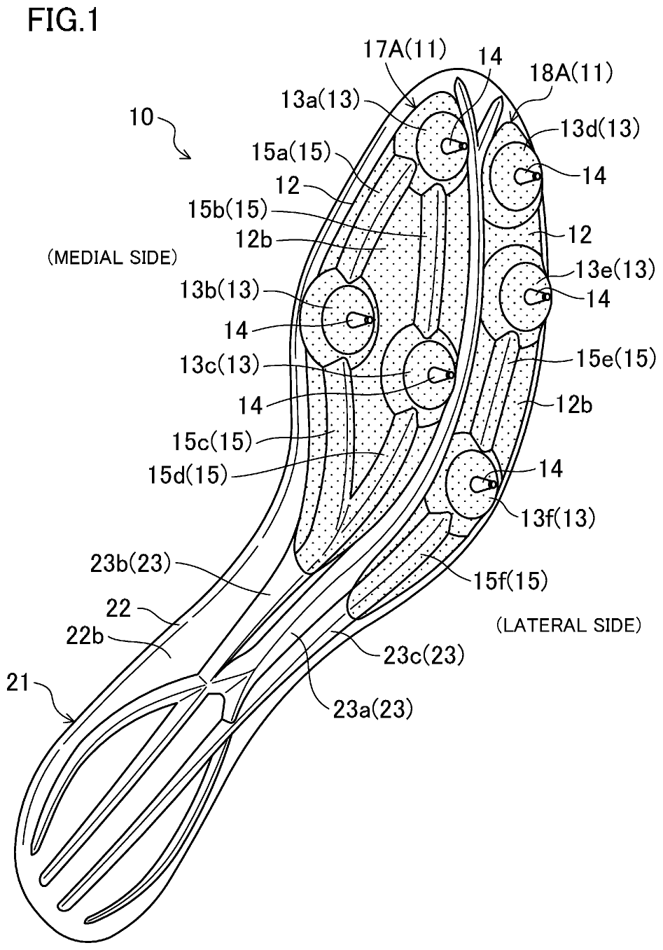

FIG. 1 illustrates an overall sole structure member 10 according to a first embodiment of the present disclosure. The sole structure member 10 according to the first embodiment is configured as an outsole for supporting a region from a forefoot portion to a midfoot portion of a foot of a person wearing a shoe (hereinafter referred to as the “wearer”). A pair of shoes each including the sole structure member 10 are used as sports shoes (spike shoes) for athletic sports, ball games, or any other sports, for example. In the first embodiment, if the sole structure member 10 is used as the outsole of the shoe, the surface of the sole structure member 10 is exposed to the outside.

The drawings show the sole structure member 10 for a left shoe (not shown) only. A sole structure member for a right shoe is symmetrical to the sole structure member for the left shoe. In the following description, only the sole structure member for the left shoe will be described and the description of the sole structure member for the right shoe will be omitted.

In the following description, the expressions “above,” “upward,” “on a/the top of,” “below,” “under,” and “downward,” represent the vertical positional relationship between components of the sole structure member 10. The expressions “front,” “fore,” “forward, “rear,” “back,” “hind,” “behind,” and “backward” represent the positional relationship in the longitudinal direction between components of the sole structure member 10. The expressions “medial side” and “lateral side” represent the positional relationship in the foot width direction between components of the shoe including the sole structure member 10.

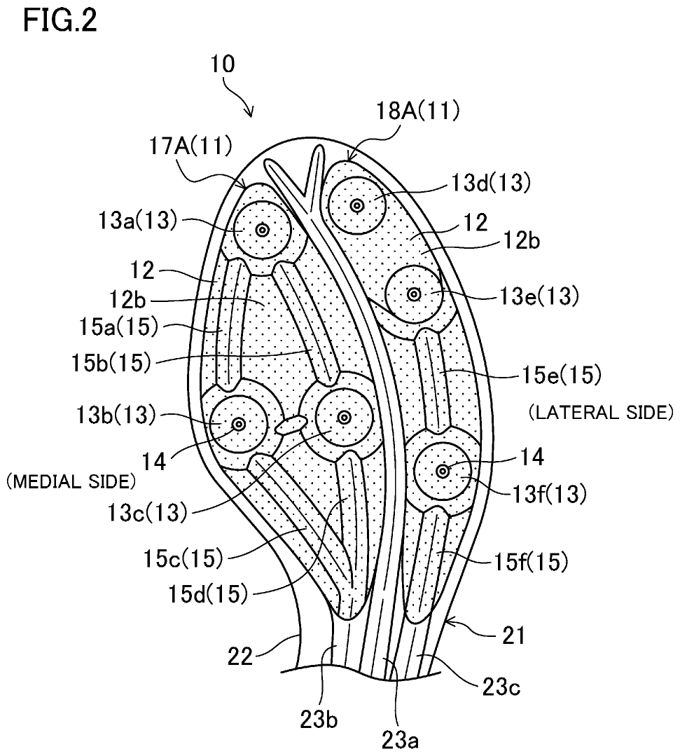

As shown in FIGS. 1 and 2, the sole structure member 10 includes first sub-members 11 and a second sub-member 21.

(First Sub-Member)

The first sub-members 11 are made of a first resin material. The first resin material is less rigid than a second resin material. In one preferred embodiment, the first resin material is a transparent resin material.

In one preferred embodiment, the first resin material is capable of withstanding the pressure and temperature in “(3) molding” of the second sub-member 21 in the production method to be described below. For example, when a relatively rigid resin material in a solid state such as polyamide (PA) is used as the first resin material, the first resin material is less likely to deform even under high temperature and high pressure in the molding. Hence, the sole structure member 10 may be obtained easily in a stable manner. In contrast, when a relatively soft material such as urethane foam is used as the first resin material, the first resin material is likely to deform under the high temperature and high pressure. Hence, it would be difficult to obtain the sole structure member 10 in a stable manner.

In one preferred embodiment, the first resin material is a material having a melting point higher than a molding temperature of the second resin material. In contrast, if the molding temperature of the second resin material rises above the melting point of the first resin material, there will be the risk that the first sub-members 11 might melt in “(3) molding” to be described below. Hence, it would be difficult to obtain the sole structure member 10 in a stable manner.

(First Body Portion)

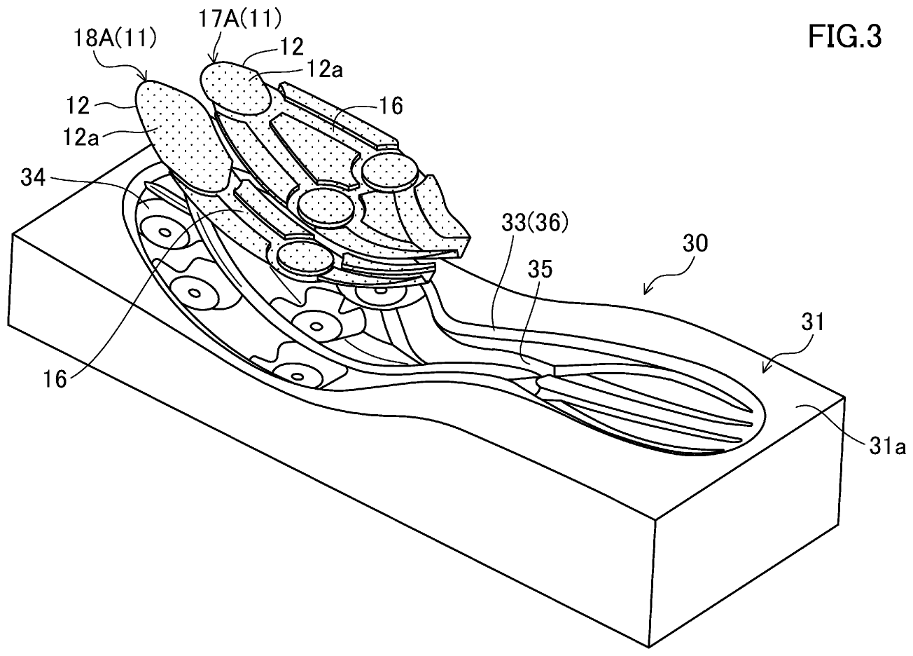

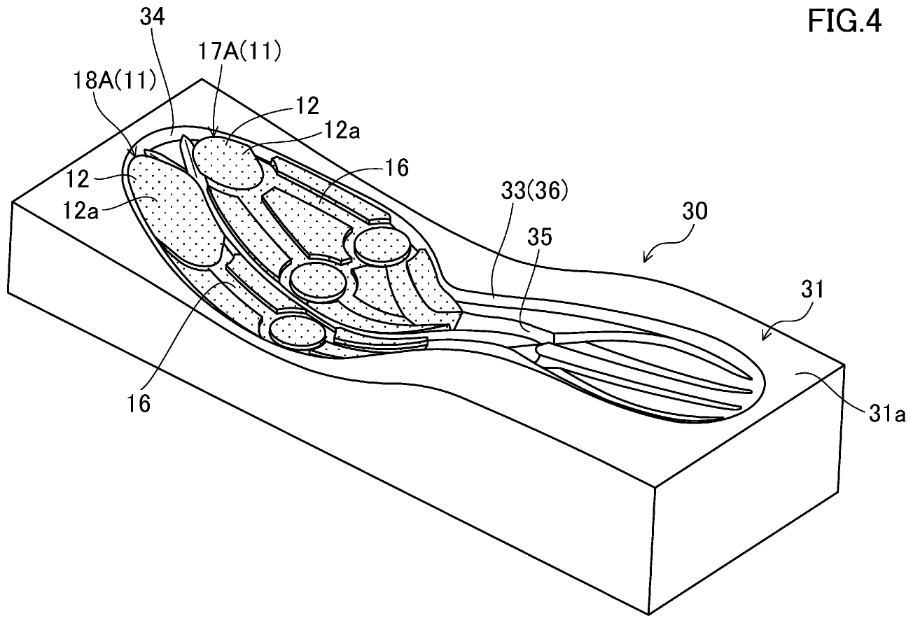

As shown in FIGS. 1 and 2, the first sub-members 11 each include a first body portion 12. The first body portion 12 has substantially a plate-like shape. As shown also in FIGS. 3 and 4, the first body portion 12 has an upper surface 12a and a lower surface 12b. If the sole structure member 10 is used for a shoe (not shown), the first body portion 12 is positioned to correspond to the forefoot portion of the wearer's foot such that the lower surface 12b faces the ground or a road surface.

(Base Portion)

As shown in FIGS. 1 and 2, the first sub-members 11 each include a plurality of base portions 13, 13, . . . . The base portions 13 are made of the first resin material and are integrated with the associated first body portion 12. The base portions 13 protrude downward from the lower surface 12b of the associated first body portion 12. The base portions 13 have substantially a circular shape, as viewed from the bottom. The base portions 13, 13, . . . , are spaced apart from each other in the length or width direction of the wearer's foot.

The base portions 13 each include a cleat 14. The cleats 14 are made of a metal material, such as an iron material. Each of the cleats 14 protrudes so as to be tapered downward from a lower surface of an associated one of the base portions 13.

(First Ribbed Portion)

The first sub-members 11 each include a plurality of first ribbed portions 15, 15, . . . . The first ribbed portions 15 are made of the first resin material. The first ribbed portions 15 are integrated with the associated first body portion 12. The first ribbed portions 15 protrude downward from the lower surface 12b of the associated first body portion 12. If the sole structure member 10 is used for a shoe (not shown), the first ribbed portions 15 extend along the length or width direction of the wearer's foot. The first ribbed portions 15 are each integrated with an associated one of the base portions 13 such that at least one end thereof is continuous with the associated base portion 13.

(Recess)

As shown in FIGS. 3 to 6, the first sub-members 11 each have a recess 16 having a closed end. The recess 16 is recessed downward from the upper surface 12a of the associated first body portion 12. The recess 16 is positioned to overlap with the associated base portions 13 and the associated first ribbed portions 15 in a vertical direction. Specifically, portions of the recess 16 overlapping with the respective base portions 13 in the vertical direction each have substantially an annular shape along the periphery of an associated one of the base portions 13, whereas portions of the recess 16 overlapping with the respective first ribbed portions 15 in the vertical direction extend along the foot length direction or the foot width direction.

(Optional Group)

In a method for producing a sole structure member 10 to be described below, an optional group consisting of a plurality of types of first sub-members 11, 11, . . . , is prepared. These first sub-members 11, 11, . . . , are premolded such that their respective recesses 16 have different configurations. Such an optional group is a feature of the present disclosure. Specifically, the optional group consists of a plurality of types of first sub-members 11, 11, . . . , which are premolded such that their respective recesses 16 vary in at least one of shape, relative position, or number.

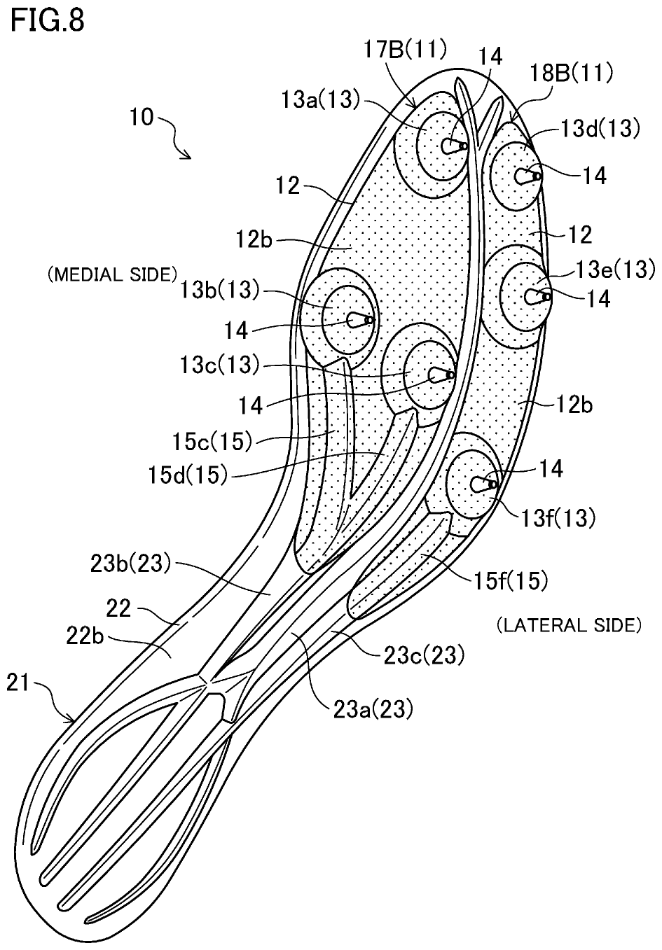

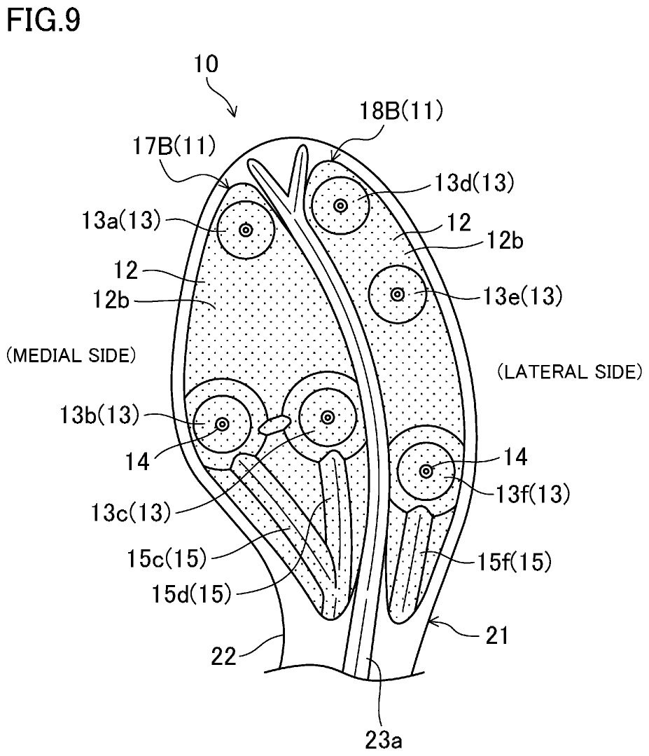

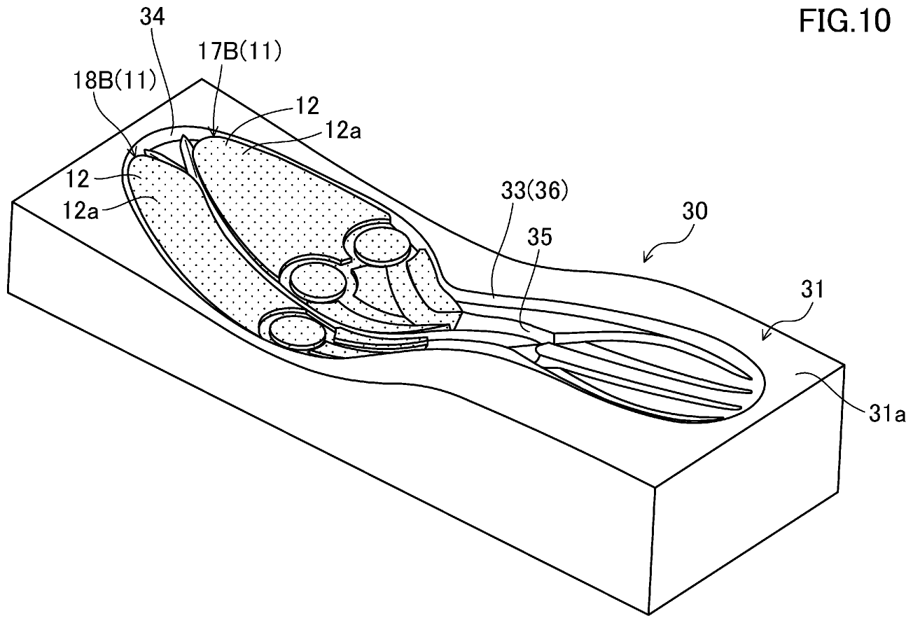

The first embodiment exemplifies a case where the first sub-members 11, 11 of a pattern A is selected from the optional group (see FIGS. 1 to 7), and a case where the first sub-members 11, 11 of a pattern B is selected from the optional group (see FIGS. 8 to 11). The optional group includes, in addition to the first sub-members 11 of the patterns A and B, a plurality of types of premolded first sub-members 11.

(First Sub-Members of Pattern A)

As shown in FIGS. 1 to 7, the first sub-members 11, 11 of the pattern A are respectively configured as a medial side first sub-member 17A and a lateral side first sub-member 18A.

The medial side first sub-member 17A is positioned to correspond to the medial side of the wearer's foot. The medial side first sub-member 17A includes three base portions 13a to 13c and four first ribbed portions 15a to 15d.

The base portion 13a is positioned to correspond to a toe portion of the wearer's foot. The base portions 13b and 13c are positioned near a position corresponding to the MTP joints of the wearer's foot, and are spaced apart from each other in the foot width direction.

The first ribbed portions 15a to 15d extend along the foot length direction. The first ribbed portion 15a is disposed between the base portions 13a and 13b. The first ribbed portion 15b is disposed between the base portions 13a and 13c. The first ribbed portions 15c and 15d are disposed behind the base portions 13b and 13c, respectively. The first ribbed portions 15c and 15d are formed such that their respective rear ends are connected together.

The lateral side first sub-member 18A is positioned to correspond to the lateral side of the wearer's foot. The lateral side first sub-member 18A includes three base portions 13d to 13f and two first ribbed portions 15e and 15f.

The base portion 13d is positioned to correspond to the toe portion of the wearer's foot. The base portion 13e is disposed behind the base portion 13d and in front of the MTP joints of the wearer's foot. The base portion 13f is disposed behind the base portion 13e and behind the MTP joints of the wearer's foot.

The first ribbed portions 15e and 15f extend along the foot length direction. The first ribbed portion 15e is disposed between the base portions 13e and 13f The first ribbed portions 15f is disposed behind the base portion 13f.

(First Sub-Members of Pattern B)

As shown in FIGS. 8 to 11, the first sub-members 11, 11 of the pattern B are respectively configured as a medial side first sub-member 17B and a lateral side first sub-member 18B.

The medial side first sub-member 17B includes three base portions 13a to 13c and two first ribbed portions 15c and 15d. In other words, the medial side first sub-member 17B does not include the first ribbed portions 15a and 15b described above. The lateral side first sub-member 18B includes three base portions 13d to 13f and one first ribbed portion 15f In other words, the lateral side first sub-member 18B does not include the first ribbed portion 15e described above.

As described above, the first sub-members 11, 11 of the pattern A and the first sub-members 11, 11 of the pattern B are premolded such that the recess 16 of each of the first sub-members 11, 11 of the pattern A has a configuration different from that of the recess 16 of each of the first sub-members 11, 11 of the pattern B.

(Second Sub-Member)

The second sub-member 21 is made of the second resin material. The second sub-member 21 has a rigidity different from that of the first resin material. In the first embodiment, the second resin material is more rigid than the first resin material. Specifically, suitable examples of the second resin material include resin materials such as polyether block amide (PEBA), polyamide (PA), or thermoplastic polyurethane (TPU).

(Second Body Portion)

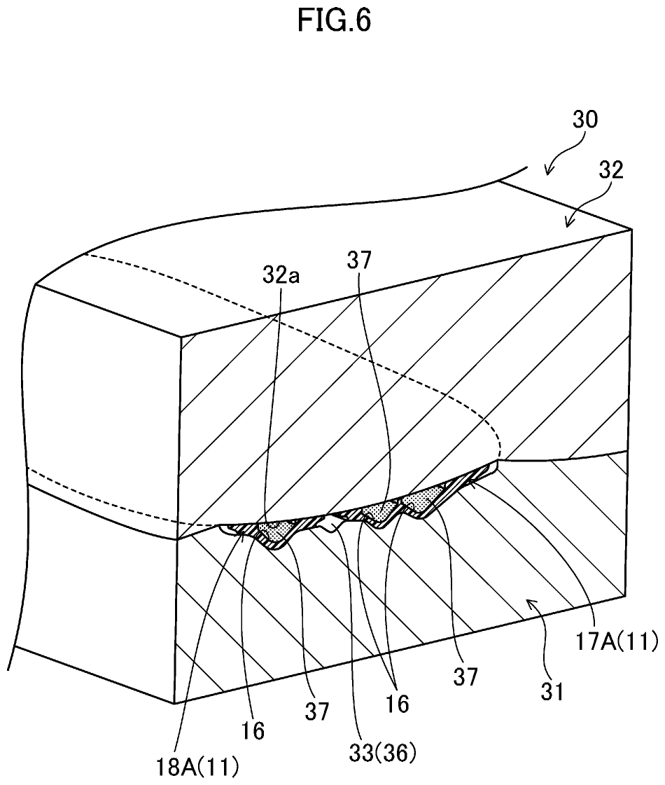

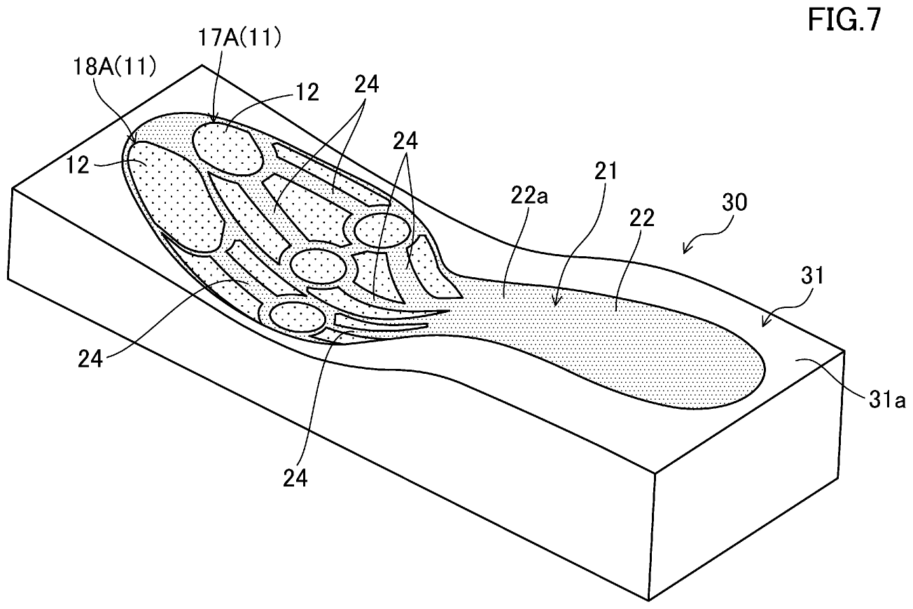

As shown in FIGS. 1 and 2, the second sub-member 21 includes a second body portion 22. The second body portion 22 has substantially a plate-like shape. As shown also in FIGS. 6 and 7, the second body portion 22 has an upper surface 22a and a lower surface 22b. If the sole structure member 10 is used for a shoe (not shown), the second body portion 22 is positioned to correspond to the midfoot portion and a hindfoot portion of the wearer's foot such that the lower surface 22b faces the ground or a road surface. The upper surface 22a of the second body portion 22 is flush with the upper surface 12a of the first body portion 12.

(Second Ribbed Portion)

As shown in FIGS. 1 and 2, the second sub-member 21 includes a plurality of second ribbed portions 23, 23, . . . . The second ribbed portions 23 are made of the second resin material. The second ribbed portions 23 are integrated with the second body portion 22. The second ribbed portions 23 protrude downward from the lower surface 22b of the second body portion 22. If the sole structure member 10 is used for a shoe (not shown), the second ribbed portions 23 extend along the foot length direction.

The second ribbed portions 23 include three second ribbed portions 23a to 23c.

The second ribbed portion 23a is positioned at substantially the center in the foot width direction. Specifically, the second ribbed portion 23a has a portion corresponding to the forefoot portion of the wearer's foot and positioned in the gap between the first sub-members 11 and 11. The second ribbed portion 23a extends from the midfoot portion to forefoot portion of the wearer's foot. The second ribbed portion 23a has a front portion branching in two directions (toward the medial and lateral sides of the toe portion of the wearer's foot). Furthermore, the second ribbed portion 23a has a rear portion branching in two directions (toward the medial and lateral sides of the wearer's foot) from the midfoot portion to hindfoot portion of the wearer's foot.

The second ribbed portion 23b is disposed near the medial side. The second ribbed portion 23b extends from the hindfoot portion to midfoot portion of the wearer's foot. The second ribbed portion 23b has a front end continuous with rear ends of the first ribbed portions 15c and 15d.

The second ribbed portion 23c is disposed near the lateral side. The second ribbed portion 23c extends from the hindfoot portion to midfoot portion of the wearer's foot. The second ribbed portion 23c has a front end continuous with a rear end of the first ribbed portion 15f.

(Branch Portion)

As shown in FIG. 7, the second sub-member 21 includes a plurality of branch portions 24, 24, . . . . The branch portions 24, 24, . . . , are made of the second resin material that fills inside the recesses 16 of the first sub-members 11 (a plurality of channels 37 to be described below) in the molding of the sole structure member 10. The branch portions 24, 24, . . . , are continuous with the second body portion 22. The branch portions 24, 24, . . . , are positioned to correspond to the recesses 16 of the first sub-members 11 in a state in which the first and second sub-members 11 and 21 are integrated together. The branch portions 24, 24, . . . , are arranged to overlap with the base portions 13 and first ribbed portions 15 of the first sub-members 11 in the vertical direction.

(Mold Apparatus)

Next, the sole structure member 10 is produced by injection molding using, for example, a mold apparatus 30 illustrated in FIGS. 3 to 7. An example of the mold apparatus 30 is shaped into a substantially rectangular shape, and includes cavity molds; namely, a lower mold 31 and an upper mold 32.

As to the mold apparatus 30, for example, the upper mold 32 vertically moves with respect to the lower mold 31. The mold apparatus 30 has a gate (not shown) communicating with a molding space 36 and the channels 37 to be described below. The gate is configured to inject the second resin material into the molding space 36 and the channels 37.

As shown in FIGS. 3 to 7, the mold apparatus 30 includes the molding space 36 for molding the sole structure member 10. Specifically, the molding space 36 is configured as a space surrounded by a cavity 33 to be described below and a lower surface 32a of the upper mold 32 in a state in which the upper mold 32 is placed on top of the lower mold 31. The molding space 36 is configured such that the second resin material injected from the gate flows thereinto during the molding of the sole structure member 10. The molding space 36 includes a molding recess 35 for molding the second ribbed portions 23.

The lower mold 31 has an upper surface 31a curved as viewed from side. The lower mold 31 has the cavity 33. The cavity 33 is recessed downward from the upper surface 31a of the lower mold 31. The cavity 33 has an outer shape identical to that of the sole structure member 10 as viewed from above.

The cavity 33 (the inside of the molding space 36) includes a housing 34 capable of housing the first sub-members 11. In other words, the housing 34 is configured as a portion of the molding space 36. The housing 34 is formed to conform to the shapes of lower portions of the first sub-members 11, 11.

The upper mold 32 has no cavity. The lower surface 32a of the upper mold 32 is curved to conform to the shape of the upper surface 31a of the lower mold 31 as viewed from side.

As shown in FIG. 6, the molding space 36 has the channels 37, 37, . . . . Specifically, the channels 37 are configured as substantially tunnel-like spaces surrounded by the recesses 16 of the first sub-members 11 housed in the housing 34 and by the inner wall surface of the molding space 36 (i.e., the lower surface 32a of the upper mold 32) in the state in which the upper mold 32 is placed on top of the lower mold 31. The channels 37 are configured such that the second resin material injected from the gate flows thereinto during the molding of the sole structure member 10.

(Method for Producing Sole Structure Member)

Next, a method for producing a sole structure member 10 including first sub-members 11, 11 (17A, 18A) of the pattern A will be described with reference to FIGS. 3 to 7. This method mainly includes (1) selecting at least one first sub-member 11, (2) inserting, and (3) molding. Note that, in FIG. 7, the second sub-member 21 is hatched with smaller dots than those for the first sub-members 11, 11 so that the second sub-member 21 is distinguished from the first sub-members 11, 11 and the mold apparatus 30.

(1) Selecting First Sub-Member

In the selecting, first sub-members 11, 11 are selected from an optional group consisting of a plurality of types of first sub-members 11, 11, . . . , which are premolded such that their respective recesses 16 have different configurations.

(2) Inserting

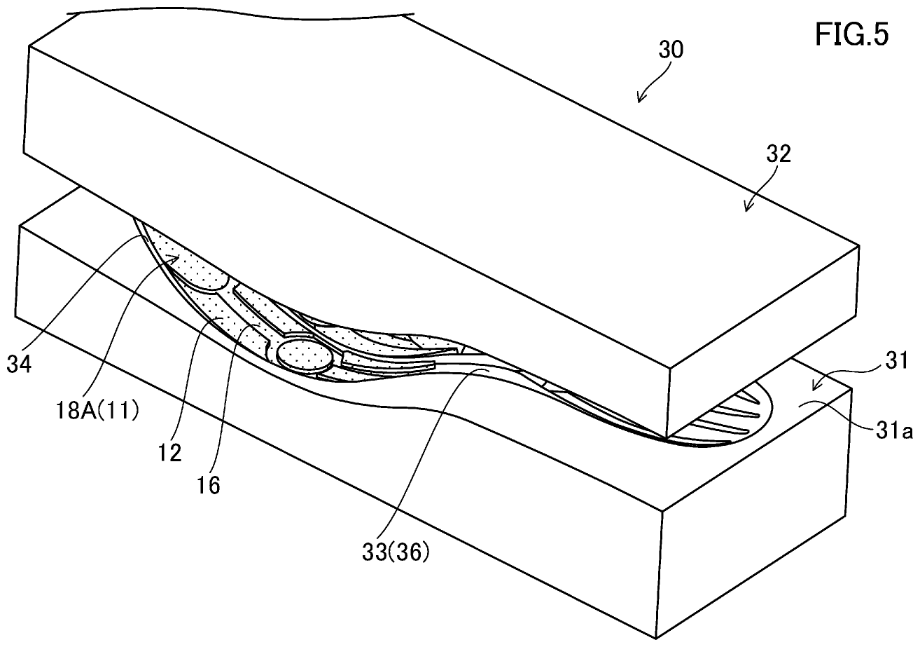

In the inserting, at least one first sub-member 11 selected from the optional group is housed in the housing 34. In the first embodiment, the first sub-members 11, 11 are housed in the housing 34. Specifically, the upper mold 32 is raised while the lower mold 31 is secured on, for example, a not-shown installation table, so that the upper and lower parts of the mold apparatus 30 are vertically separated from each other (see FIGS. 3 and 4). Next, the first sub-members 11, 11 are housed in the housing 34 of the lower mold 31. After this housing operation, the upper mold 32 is placed on top of the lower mold 31 (see FIGS. 5 and 6).

(3) Molding

Next, in the molding, the second resin material to form the second sub-member 21 is injected (fed) into the mold apparatus 30 so that the first sub-members 11, 11 and the second sub-member 21 are integrated together. Specifically, the second resin material is heated to melt by a not-shown injection molder. Then, the second resin material is injected from the gate of the mold apparatus 30 into the molding space 36 and the channels 37. In this state, a temperature for molding the second resin material is appropriately set so that the temperature is suitable to the materials to form the second sub-member 21. After the second resin material fills in the molding space 36 and the channels 37 in the mold apparatus 30, the mold apparatus 30 undergoes a predetermined cooling treatment. Hence, the first sub-members 11, 11 and the second sub-member 21 are integrated together. After the end of the cooling treatment, the upper mold 32 is raised and the sole structure member 10 is taken out (see FIG. 7).

Through the processes (1) to (3), the sole structure member 10 can be obtained.

### Advantages of First Embodiment

As described above, the method for producing the sole structure member 10 according to the first embodiment includes selecting at least one first sub-member 11 from an optional group consisting of a plurality of types of first sub-members 11, 11, . . . , which are premolded such that their respective recesses 16 have different configurations. For example, if, in this process, the first sub-members 11, 11 of two patterns (the patterns A and B) are appropriately selected from the optional group, the difference in the configuration of the recess 16 between these patterns causes the branch portions 24, 24, . . . , of the second sub-member 21, which are molded through injection of the second resin material from the gate into the channels 37 in the molding, to have configurations that differ between the patterns. Specifically, a sole structure member 10 including first sub-members 11, 11 of one of the patterns (e.g., the pattern A) has a rigidity different from that of a sole structure member 10 including first sub-members 11, 11 of the other pattern (e.g., the pattern B), due to the configurations of the branch portions 24, 24, . . . , that differ between the patterns. As a result, a plurality of types of sole structure members 10 having basically the same outer shapes and different only in rigidity can be produced using the single mold apparatus 30. Thus, in the first embodiment, a plurality of types of sole structure members having rigidities suitable for wearers' characteristics or preferences can be easily provided. Further, since a plurality of types of sole structure members 10 having different rigidities can be produced using one mold apparatus 30, the production cost can also be reduced.

Since the second resin material is more rigid than the first resin material, the rigidity of the branch portions 24, 24, . . . , of the second sub-member 21 can be appropriately changed depending on the size, relative position, and number of the recess(es) 16 of the first sub-member 11 selected from the optional group. Thus, in producing the sole structure member 10, its rigidity can be easily adjusted to be suitable for wearers' characteristics or preferences.

In the first embodiment, the number of the branch portions 24, 24, . . . , of the second sub-member 21 of the sole structure member 10 including the first sub-members 17A and 18A of the pattern A is greater than the number of the branch portions 24, 24, . . . , of the second sub-member 21 of the sole structure member 10 including the first sub-members 17B and 18B of the pattern B. Thus, the sole structure member 10 including the first sub-members 17A and 18A has a relatively higher bending rigidity than the sole structure member 10 including the first sub-members 17B and 18B.

Further, since the first resin material is a transparent resin material, the first sub-members 11 look transparent. Thus, when the sole structure member 10 is viewed, the features (the shape, relative positions, number, and other features) of the branch portions 24, 24, . . . , corresponding in position to the recess 16 is more easily recognized. This configuration enables easy production of a sole structure member 10 having a degree of rigidity that is visible based on the visual features of the branch portions 24, 24, . . . .

In a state in which the sole structure member 10 is used for a shoe, the first sub-members 11 each have the recess 16 extending in the length direction of the foot of the wearer wearing the shoe. This enables easy production of a sole structure member 10 configured to increase the bending rigidity of the shoe in the foot length direction.

Further, in the state in which the sole structure member 10 is used for a shoe, the first sub-members 11 each have the recess 16 positioned to correspond to the MTP joints of the foot of the wearer wearing the shoe. This configuration enables easy production of a sole structure member 10 configured to increase the rigidity of a portion of the shoe corresponding to the MTP joints of the wearer's foot.

### Second Embodiment

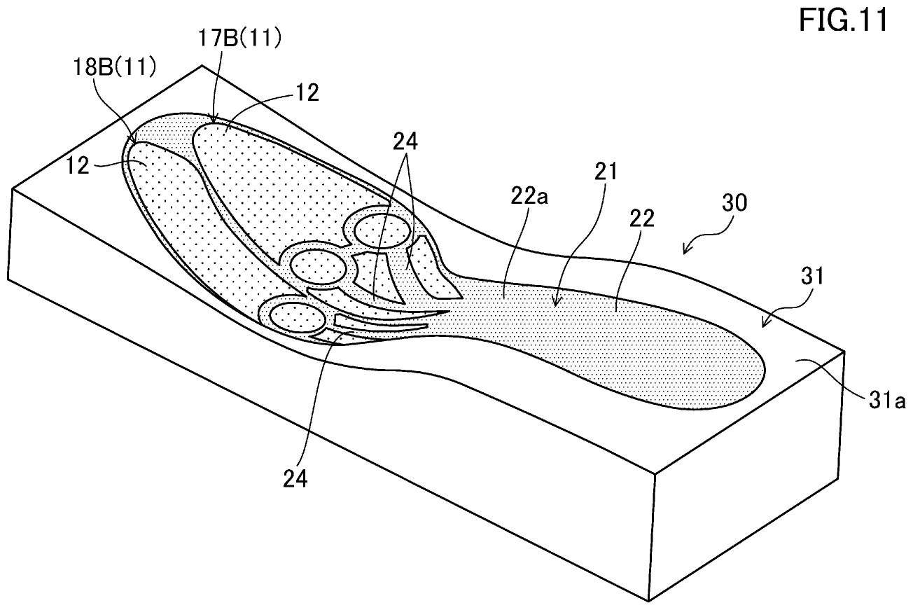

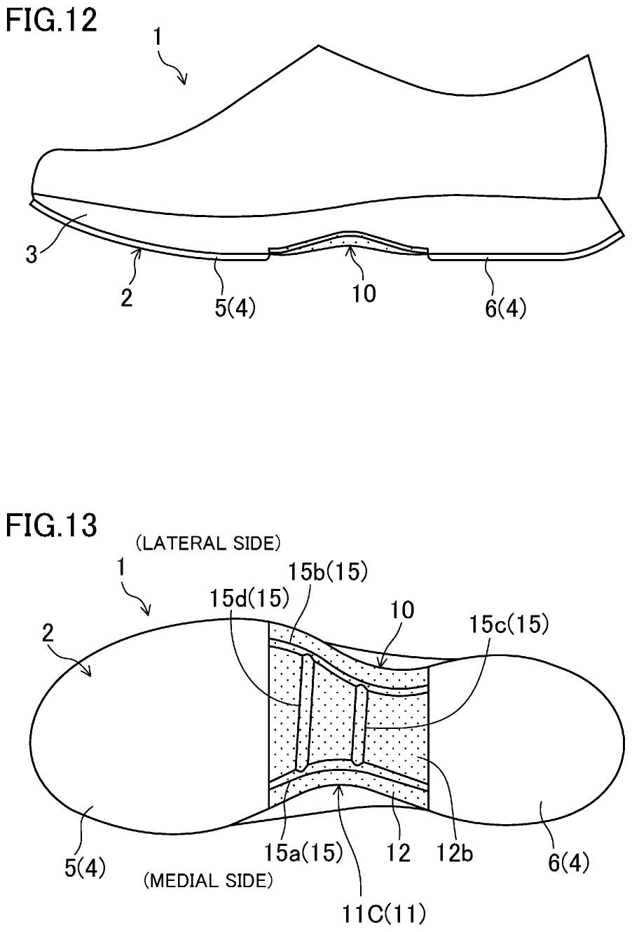

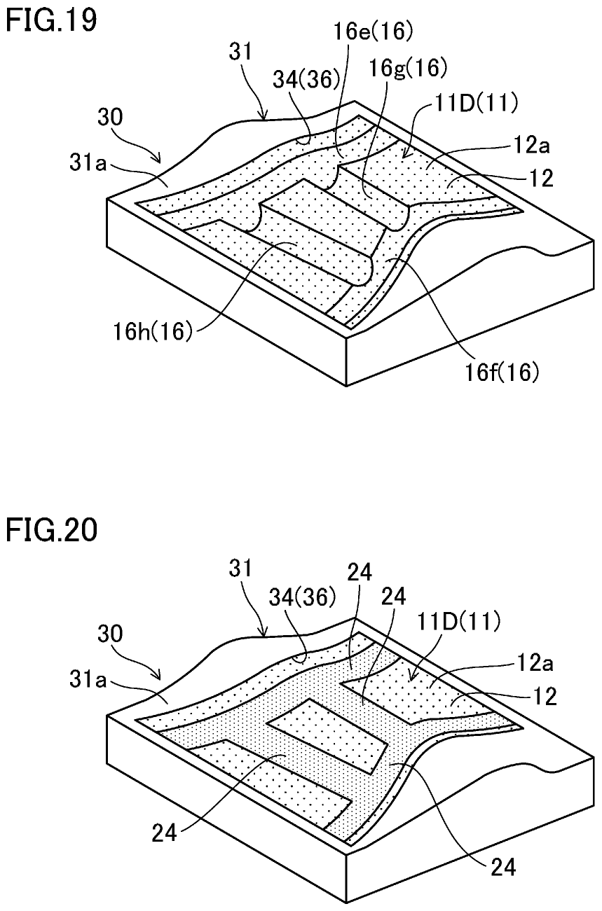

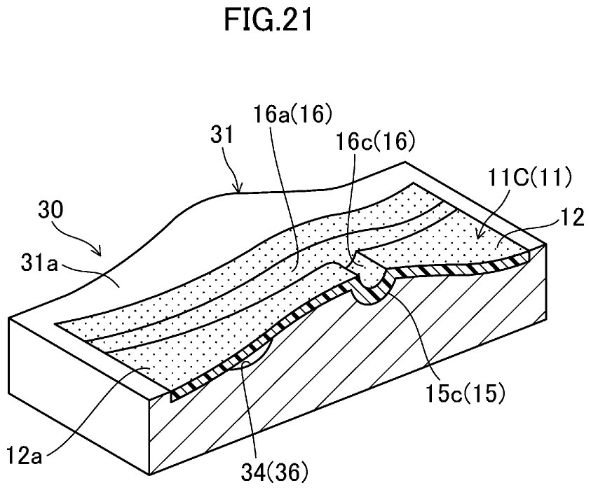

FIGS. 12 to 20 illustrate a sole structure member 10 and a mold apparatus 30 for producing the sole structure member 10 according to a second embodiment of the present disclosure. The sole structure member 10 and the mold apparatus 30 in the second embodiment are partially different from those in the first embodiment. Note that other configurations of the sole structure member 10 and the mold apparatus 30 according to the second embodiment are the same as those of the sole structure member 10 and the mold apparatus 30 according to the first embodiment. Therefore, elements that are the same as those shown in FIGS. 1 to 11 are denoted by the corresponding reference characters, and detailed descriptions thereof are omitted herein.

FIGS. 12 and 13 illustrate an overall shoe 1 including the sole structure member 10 according to the second embodiment of the present disclosure. A pair of shoes 1 may be used, for example, as sport shoes for various kinds of sports, such as running and ball games, sneakers for daily use, or rehabilitation shoes.

The shoe 1 includes a sole structure 2. The sole structure 2 includes a midsole 3 and outsoles 4. The outsoles 4, 4 include a front outsole portion 5 and a rear outsole portion 6. The front and rear outsole portions 5 and 6 are spaced apart from each other in the foot length direction.

The sole structure member 10 according to the second embodiment is configured as a shank plate for supporting the midfoot portion (mainly an arch portion) of the wearer's foot on the shoe 1. Specifically, the sole structure member 10 is disposed under the midsole 3 and between the front and rear outsole portions 5 and 6 in the foot length direction. The shoe 1 shown in FIGS. 12 and 13 is configured such that the surface of the sole structure member 10 is exposed to the outside.

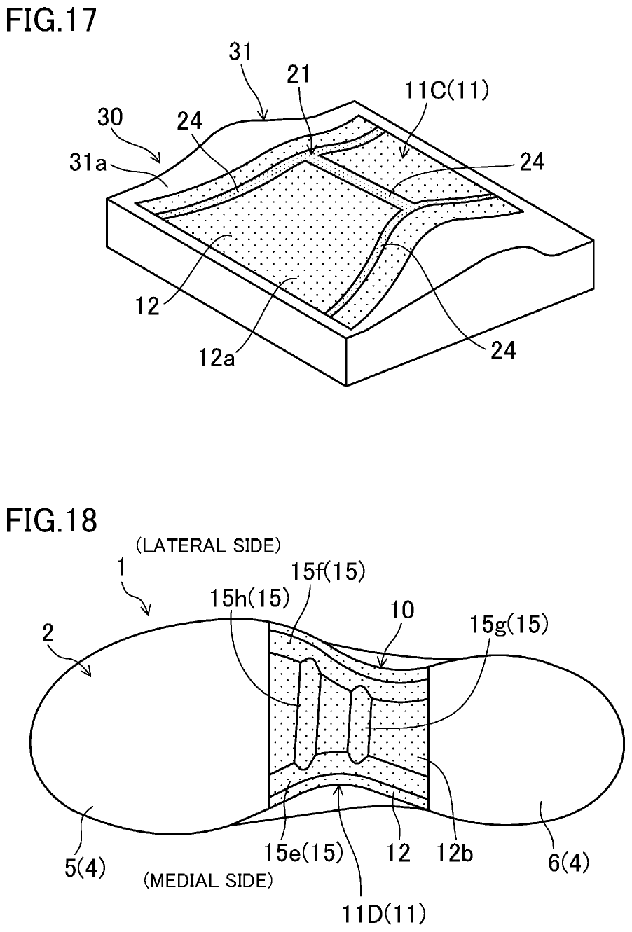

As shown in FIGS. 17, the sole structure member 10 includes a first sub-member 11 and a second sub-member 21.

(First Sub-Member)

The first sub-member 11 is made of a first resin material. Since the first resin material is the same as that in the first embodiment, a detailed description thereof will be omitted herein.

(First Body Portion)

As shown in FIGS. 12 to 17, the first sub-member 11 includes a first body portion 12. The first body portion 12 has substantially a plate-like shape. The first body portion 12 has an upper surface 12a and a lower surface 12b. If the sole structure member 10 is used for a shoe 1, the first body portion 12 is positioned to correspond to the midfoot portion of the wearer's foot such that the lower surface 12b faces the ground or a road surface.

(First Ribbed Portion)

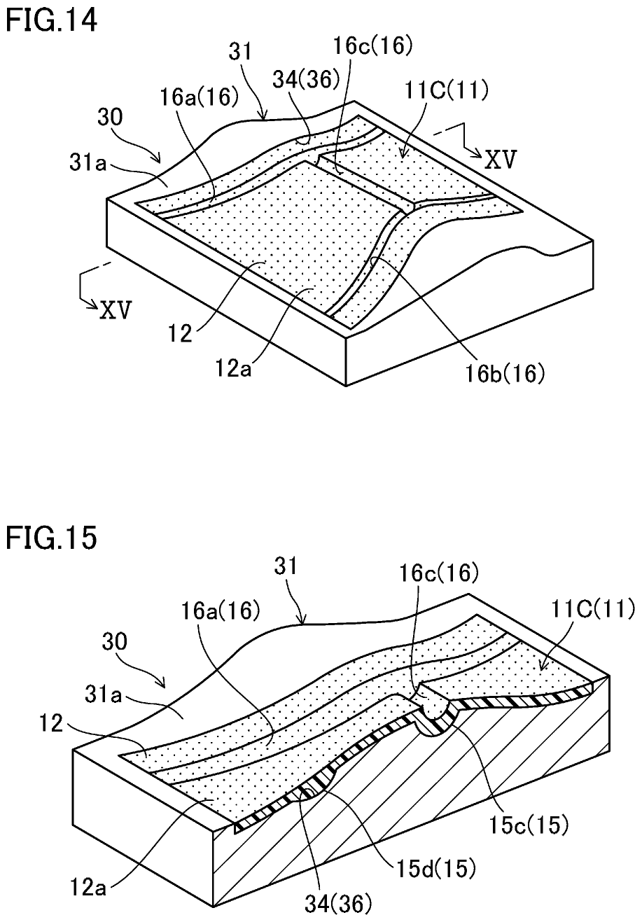

The first sub-members 11 each include a plurality of first ribbed portions 15, 15, . . . . The first ribbed portions 15 are made of the first resin material. The first ribbed portions 15 are integrated with the first body portion 12. The first ribbed portions 15 protrude downward from the lower surface 12b of the first body portion 12 (see FIGS. 13 and 15). If the sole structure member 10 is used for the shoe 1, the first ribbed portions 15 extend along the length or width direction of the wearer's foot.

(Recess)

As shown in FIGS. 14 to 16, the first sub-member 11 has recesses 16, 16, . . . , each having a closed end. The recesses 16, 16, . . . , are recessed downward from a lower surface of the first body portion 12. The recesses 16, 16, . . . , are positioned to overlap with the first ribbed portions 15 in a vertical direction. Specifically, portions of the recesses 16 overlapping with the respective first ribbed portions 15 in the vertical direction extend along the foot length direction or the foot width direction.

(Optional Group)

Also in the second embodiment, just like the first embodiment, an optional group consisting of a plurality of types of first sub-members 11, 11, . . . , is prepared. These first sub-members 11, 11, . . . , are premolded such that their respective recesses 16, 16, . . . , have different configurations. The second embodiment exemplifies a case where a first sub-member 11C of a pattern C is selected from the optional group (see FIGS. 13 to 17), and a case where a first sub-member 11D of a pattern D is selected from the optional group (see FIGS. 18 to 20). The optional group includes, in addition to the first sub-members 11C and 11D of the patterns C and D, a plurality of types of premolded first sub-members 11.

(First Sub-Member of Pattern C)

As shown in FIGS. 13 to 17, the first sub-member 11C of the pattern C has four first ribbed portions 15a to 15d and three recesses 16a to 16c. Each of the first ribbed portions 15a and 15b extends in the foot length direction. The first ribbed portion 15a is disposed near the medial side. The first ribbed portion 15b is disposed near the lateral side. Each of the first ribbed portions 15c and 15d extends in the foot width direction. The first ribbed portions 15c is disposed behind the first ribbed portion 15d.

The recess 16a is positioned to overlap with the first ribbed portion 15a in a vertical direction. The recess 16b is positioned to overlap with the first ribbed portion 15b in the vertical direction. The recess 16c is positioned to overlap with the first ribbed portion 15c in the vertical direction. A portion of the first sub-member 11C overlapping with the first ribbed portion 15d in the vertical direction has no recess 16.

(First Sub-Member of Pattern D)

As shown in FIGS. 18 to 20, the first sub-member 11D of the pattern D has four first ribbed portions 15e to 15h and four recesses 16e to 16h. Each of the first ribbed portions 15e and 15f extends in the foot length direction. The first ribbed portion 15e is disposed near the medial side. The first ribbed portion 15f is disposed near the lateral side. Each of the first ribbed portions 15g and 15h extends in the foot width direction. The first ribbed portions 15g is disposed behind the first ribbed portion 15h. The first ribbed portions 15e to 15h are wider than an associated one of the first ribbed portions 15a to 15d of the first sub-member 11C of the pattern C.

The recess 16e is positioned to overlap with the first ribbed portion 15e in the vertical direction. The recess 16f is positioned to overlap with the first ribbed portion 15f in the vertical direction. The recess 16g is positioned to overlap with the first ribbed portion 15g in the vertical direction. The recess 16h is positioned to overlap with the first ribbed portion 15h in the vertical direction. The recesses 16e to 16h are wider than an associated one of the recesses 16a to 16d of the first sub-member 11C of the pattern C.

As described above, the first sub-member 11 of the pattern C and the first sub-member 11 of the pattern D are premolded such that the recesses 16, 16, . . . , of the first sub-member 11 of the pattern C have a configuration different from that of the recesses 16, 16, . . . , of the first sub-member 11 of the pattern D.

(Second Sub-Member)

As shown in FIG. 17, the second sub-member 21 has a plurality of branch portions 24, 24, . . . . Just like the first embodiment, the branch portions 24, 24, . . . , are made of the second resin material that fills inside the recesses 16 of the first sub-member 11 (channels 37) in the molding of the sole structure member 10. The branch portions 24, 24, . . . , are positioned to correspond to the recesses 16, 16, . . . , of the first sub-member 11 in a state in which the first and second sub-members 11 and 21 are integrated together. Since the second resin material is the same as that in the first embodiment, a detailed description thereof will be omitted herein.

(Mold Apparatus)

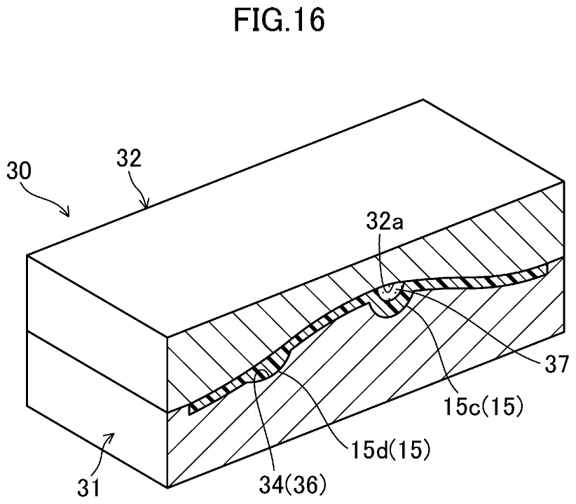

Next, the sole structure member 10 is produced by injection molding using a mold apparatus 30 illustrated in, for example, FIGS. 14 to 17. In the second embodiment, a molding space 36 (a cavity 33 of the lower mold 31) is configured as a housing 34 capable of housing the first sub-member 11. As shown in FIG. 16, the molding space 36 has the channels 37. Since the other configurations of the mold apparatus 30 is the same as those in the first embodiment, a detailed description thereof will be omitted herein.

(Method for Producing Sole Structure Member)

Just like the first embodiment, a method for producing a sole structure member 10 according to the second embodiment mainly includes (1) selecting at least one first sub-member 11, (2) inserting, and (3) molding. Since the processes (1) to (3) are the same as those in the first embodiment, a detailed description thereof will be omitted herein. Note that, in FIG. 17, the second sub-member 21 is hatched with smaller dots than those for the first sub-member 11 so that the second sub-member 21 is distinguished from the first sub-member 11 and the mold apparatus 30.

### Advantages of Second Embodiment

As described above, even in the second embodiment, just like the first embodiment, a plurality of types of sole structure members 10 having different rigidities are easily produced using one mold apparatus 30. Thus, a plurality of types of sole structure members 10 having rigidities suitable for wearers' characteristics or preferences can be easily provided.

In the second embodiment, in the state in which the sole structure member 10 is used for the sole structure 2 of the shoe 1, the recesses 16 of the first sub-member 11 are positioned to correspond to the midfoot portion of the foot of the wearer wearing the shoe 1. This configuration enables easy production of a sole structure member 10 configured to increase the rigidity of a portion of the sole structure 2 of the shoe 1 corresponding to the midfoot portion (e.g., the plantar arch) of the wearer's foot.

In the second embodiment, the number and width of the branch portions 24, 24, . . . , of the second sub-member 21 of the sole structure member 10 including the first sub-member 11D of the pattern D are greater than those of the branch portions 24, 24, . . . , of the second sub-member 21 of the sole structure member 10 including the first sub-member 11C of the pattern C. Thus, the sole structure member 10 including the first sub-member 11D has a relatively higher bending rigidity than the sole structure member 10 including the first sub-member 11C.

### Variation of Second Embodiment

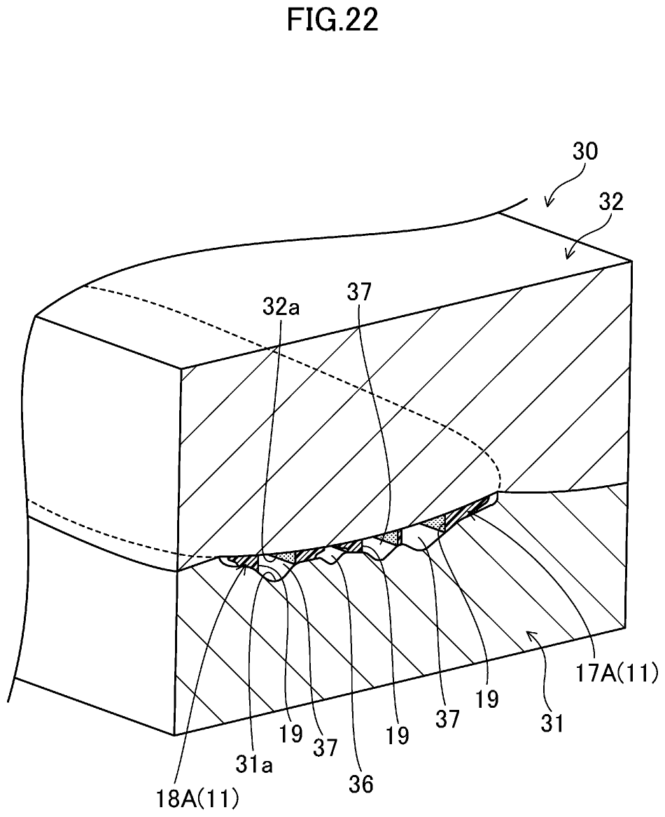

In the second embodiment, the first sub-member 11C of the pattern C having the four first ribbed portions 15a to 15d is used. However, just like a variation shown in FIG. 21, a first sub-member 11C including, for example, no first ribbed portion 15d may be used.

In this variation, a space is formed in a portion of the housing 34 (molding space 36) of the mold apparatus 30 between the lower surface 12b of the first body portion 12 and the upper surface 31a of the lower mold 31, i.e., a portion where the first ribbed portion 15d is present in the second embodiment. However, since the space is not a space into which the second resin material is to be injected, the space does not affect the molding of the first sub-member 11C and the second sub-member 21.

As described above, in the second embodiment, it is generally recommended that the first sub-member 11 have the same outer shape as the housing 34 (molding space 36) of the lower mold 31. However, as long as the first sub-member 11 is formed into a shape that can be housed in the housing 34 (molding space 36), no particular problem arises during molding even if the outer shape of the first sub-member 11 is partially modified (e.g., the first ribbed portions 15 have different protrusion heights, or portions of the first ribbed portions 15 pass through the first sub-member 11). This statement applies to the first embodiment.

### Other Embodiments

In each of the foregoing embodiments, the second resin material is more rigid than the first resin material. However, this is merely a non-limiting example. In other words, the second resin material may be less rigid than the first resin material. In short, the second resin material merely needs to have a rigidity different from that of the first resin material.

In each of the foregoing embodiments, the recess(es) 16 is (are) recessed downward from the upper surface 12a of the first body portion 12. However, this is merely a non-limiting example. In other words, the recess(es) 16 may be recessed upward from the lower surface 12b of the first body portion 12.

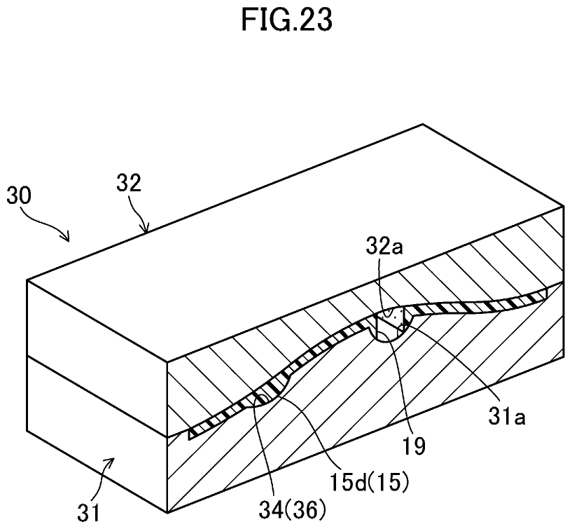

In each of the foregoing embodiments, the first sub-member 11 has the recess(es) 16 having a closed end. However, this is merely a non-limiting example. For example, as shown in FIGS. 22 and 23, the first sub-member 11 may have holes 19 passing from the upper surface 12a to lower surface 12b of the first body portion 12, instead of the recess(es) 16. Even in such a configuration, the channels 37 are formed in the state in which the upper mold 32 is placed on top of the lower mold 31. The channels 37 are configured as substantially tunnel-like spaces surrounded by the holes 19 of the first sub-members 11 and the inner wall surface of the molding space 36 (i.e., the upper surface 31a of the lower mold 31 and the lower surface 32a of the upper mold 32). The second resin material injected from the gate flows into the channels 37 during the molding of the sole structure member 10. Thus, advantages similar to those of the foregoing embodiments can be achieved.

As to the mold apparatus 30 of each of the embodiments, the upper mold 32 vertically moves with respect to the lower mold 31. However, the configuration of the mold apparatus 30 is not limited to such a configuration. For example, in the mold apparatus 30, the lower mold 31 may vertically moves with respect to the upper mold 32. Alternatively, the upper mold 32 may move in a fore-aft direction or in a transverse direction with respect to the lower mold 31.

Furthermore, as a production method of the embodiments, injection molding is utilized to obtain the sole structure member 10. However, the production method is not limited to injection molding.

For example, the sole structure member 10 may be produced by polyurethane cast molding. Using the cast molding, a molded polyurethane product is the same in shape as that produced with the mold apparatus 30. Note that, in producing the sole structure member 10 by cast molding, it is not suitable to use a material which apparently expands due to, for example, foaming after demolding, and to use a molding method causing such expansion.

An example is described in which if, just like the first embodiment, the sole structure member 10 is used as the outsole of the shoe, or if, just like the second embodiment, the sole structure member 10 is used as the shank plate of the shoe, the surface of the sole structure member 10 is exposed to the outside of the shoe. However, this is merely a non-limiting example. For example, in each of the foregoing embodiments, at least one portion of the surface of the sole structure member 10 may be covered with a cushioning member, such as a midsole (not shown).

Note that the present disclosure is not limited to the embodiment described above, and various changes and modifications may be made without departing from the scope of the present disclosure.

The present disclosure is industrially applicable as a method for producing a sole structure member for use in a shoe.

### DESCRIPTION OF REFERENCE CHARACTERS

1 Shoe
2 Sole Structure
10 Sole Structure Member
11 First Sub-member
12 First Body Portion
13 Base Portion
14 Cleat
15 First Ribbed Portion
16 Recess
19 Hole
21 Second Sub-member
22 Second Body Portion
23 Second Ribbed Portion
24 Branch Portion
30 Mold Apparatus
31 Lower Mold
32 Upper Mold
33 Cavity
34 Housing
35 Molding Recess
36 Molding Space
37 Channel

What is claimed is:

1. A method for producing a sole structure member for use in a shoe, using a mold apparatus,
the sole structure member including at least one first sub-member made of a first resin material, and a second sub-member made of a second resin material having a rigidity different from a rigidity of the first resin material,
the at least one first sub-member having a first body portion, and at least one recess or hole formed in the at least one first body portion,
the second sub-member having at least one branch portion positioned to correspond to the at least one recess or hole of the first sub-member,
the mold apparatus including:
a molding space configured to mold the sole structure member;
a housing provided inside the molding space and for housing the at least one first sub-member;
a channel configured as a space surrounded by the at least one recess or hole and the molding space; and
a gate communicating with at least either the molding space or the channel and for injecting the second resin material into the molding space and the channel,
the method comprising:
selecting the at least one first sub-member from an optional group consisting of a plurality of types of the first sub-members premolded such that their respective recesses or holes have different configurations;
inserting, and housing, in the housing the at least one first sub-member selected from the optional group; and
molding the first and second sub-members so as to be integrated together through injection of the second resin material heated to melt, from the gate into the molding space and the channel.

2. The method of claim 1, wherein
the second resin material is more rigid than the first resin material.

3. The method of claim 1, wherein
the first resin material is a transparent resin material.

4. The method of claim 1, wherein
in a state in which the sole structure member is used for the shoe, the at least one recess or hole of the at least one first sub-member extends in a length direction of a foot of a wearer wearing the shoe.

5. The method of claim 1, wherein
in a state in which the sole structure member is used for the shoe, the at least one recess or hole of the at least one first sub-member is positioned to correspond to MTP joints of a foot of a wearer wearing the shoe.

6. The method of claim 1, wherein
in a state in which the sole structure member is used for the shoe, the at least one recess or hole of the at least one first sub-member is positioned to correspond to a midfoot portion of a foot of a wearer wearing the shoe.
